(19) United States
(12) Patent Application Publication
(10) Pub. No.: US 2007/0122318 A1
(43) Pub. Date: May 31, 2007

(54) Catalytic converter

(76) Inventors: Craig F. Habeger, Chillicothe, IL (US); Michael J. Pollard, Peoria, IL (US)

Correspondence Address: CATERPILLAR INC.;100 N.E. ADAMS STREET, PATENT DEPT., PEORIA, IL, 616296490, US

(21) Appl. No.: 11/289,213

(22) Filed: Nov. 29, 2005

(51) Int. Cl. B01D 50/00; B21D 51/16

(52) U.S. Cl. 422/177; 422/180; 29/890

(57) ABSTRACT

A catalytic converter, an exhaust system comprising a catalytic converter, and a method of manufacturing a catalytic converter are provided. The catalytic converter comprises at least one channel configured to receive gas flow and a catalyst coated on the at least one channel. In one of the disclosed embodiments, at least one channel is partially non-linear along its length.

### TECHNICAL FIELD

The present disclosure relates to a catalytic converter, an exhaust system of an internal combustion engine comprising a catalytic converter, and a method for manufacturing a catalytic converter. More particularly, the present disclosure relates to a catalytic converter that is configured to partially catalyze at least a portion of unwanted combustion byproducts that are emitted from the exhaust system of an internal combustion engine.

### BACKGROUND

There are millions of engines in use throughout the world. Many of these engines are internal combustion engines, including diesel and gasoline-fueled engines for automobiles. Most of these engines, unfortunately, emit environmentally-harmful air pollutants, such as nitrogen oxides (“NOx”), unburned fuel or hydrocarbons, and carbon monoxides, to name a few.

In an effort to minimize the production of these harmful pollutants, governments within the United States and throughout the world continue to pass clean-air legislation, which regulates the amount of harmful emissions that engines may lawfully produce. To keep up with clean-air legislation, engine manufacturers must continually refine engine technology. One area of engine technology that is often improved for meeting stringent regulations is catalytic converter technology.

A catalytic converter is a device that uses a chemical catalyst to help convert various harmful emissions of the engine's exhaust into harmless—or less harmful—chemical compounds. As previously mentioned, some of these harmful emissions include hydrocarbons, NOx, and carbon monoxide.

Some catalytic converters are manufactured from a ceramic structure, such as a honeycomb, which is then coated with a catalyst and later housed in a muffler-like package attached to an exhaust pipe. Other catalytic converters comprise metallic foils, which are then rolled about an axis to form a cylindrical structure, which is then housed in a muffler-like package attached to the exhaust pipe. In these rolled catalytic converters, the catalyst may be applied either before or after the foils are wound together. The converter usually comprises numerous neighboring channels, through which exhaust gas flows.

Most catalytic converters are coated with a chemical catalyst. These catalysts may comprise a precious metal, such as rhodium, platinum, and palladium, for example. Some catalysts, for example, help to convert carbon monoxide into carbon dioxide. Other catalysts may help to convert hydrocarbons into carbon dioxide and water, while even other catalysts may help to convert NOx into nitrogen and oxygen.

If the catalytic converter is made from a ceramic substrate, the converter may be manufactured by extrusion, which results in channels having straight channels along their entire length.

If the catalytic converter is made from metal, corrugated strips or foils are alternatively arranged with flat strips, both of which are then wound around an axis or around multiple axes such as the Emitec design. The resulting channel cross-sectional shape is usually rectangular or trapezoidal. Additionally—as with the channels in ceramic substrate converters—the resulting channels in metal converters are also typically straight along their entire length.

Because many of the catalytic converters of either the ceramic or metallic type have generally straight channels, with smooth and even surfaces, and the velocities of the gases that flow through them are relatively low, the flow within the channels is oftentimes laminar.

In laminar fluid flow, a boundary layer is formed closest to a channel wall. At this boundary layer, the velocity of the gas is near zero. As a result, the boundary layer reduces the coefficient of mass transfer, which may reduce the catalytic converter efficiency.

A measure of the catalytic converter's efficiency depends on the conversion of harmful emissions within the converter. As such, it is desirable to have a highly efficient converter. Generally, in order for the catalytic converter to have a high efficiency, the coefficient of mass transfer, which measures the mass transfer rate, must also be high.

To increase the coefficient of mass transfer, and likewise the efficiency of the catalytic converter, the flow of exhaust gas through the channels may be changed from laminar flow to turbulent flow, although this typically increases the pressure drop across the filter. Turbulent flow may be created in several different ways. For instance, the velocity of the exhaust gas may be substantially increased, which will generate turbulent flow in the channels. Alternatively, arranging the channels so that they are not straight along their entire lengths may also create turbulent flows.

U.S. Pat. No. 6,187,274 to Nilsson (“Nilsson”) discloses a turbulence inducer in a catalytic converter channel. In Nilsson, a catalytic converter comprising longitudinal channels is disclosed. In Nilsson, the channels have first and second turbulence generators spaced apart in the longitudinal direction for making the gas flow turbulent. Also in Nilsson, each turbulence generator includes a rear face inclined forwardly at an angle of from 35° to 60° from a base of the channel and facing rearwardly, a connecting face extending forwardly from a free edge of the rear face, and a front face projecting toward the base from a front edge of the connecting face and facing forwardly.

Although Nilsson teaches using turbulence inducers to create turbulent flow in at least part of a catalytic converter channel, there are several characteristics of the catalytic converter disclosed in Nilsson that make the catalytic converter impractical. For example, due to the presence of the turbulence generators, the cost-of-manufacture of the Nilsson catalytic converter may be prohibitively expensive. Additionally, the flow within the entire length of the channel of Nilsson may still maintain laminar characteristics, depending on several factors, including the spacing between the turbulence generators.

The present disclosure is directed to overcoming one or more of the problems or disadvantages existing in the prior art.

### SUMMARY OF THE INVENTION

In one embodiment, a catalytic converter is provided. The catalytic converter may comprise at least one channel configured to receive gas flow and a catalyst coated on the at least one channel. In this embodiment, the at least one channel is at least partially non-linear along its length.

In another embodiment, an exhaust system of an internal combustion engine is provided. The system may comprise an exhaust pipe in fluid communication with an exhaust manifold of the internal combustion engine, a housing in fluid communication with the exhaust pipe, and a catalytic converter housed within the housing. The catalytic converter may comprise at least one channel configured to receive gas flow and a catalyst coated on the at least one channel. In this embodiment, the at least one channel may be non-linear along at least part of the channel length. The exhaust system may also be in which the catalytic converter is configured to at least partially catalyze an exhaust constituent.

In even another embodiment, a method of manufacturing a catalytic converter is provided. In this embodiment, the method may comprise the steps of providing at least one first metal foil, the first metal foil being substantially flat, providing at least one second metal foil, the second metal foil comprising non-linear channels, and wrapping the at least one first metal foil and the at least one second metal foil around an axis.

In even yet another embodiment, another method of manufacturing a catalytic converter is provided. In this particular embodiment, the method may comprise the steps of providing at least one foil, the foil comprising non-linear channels, and wrapping the at least one foil around an axis.

### BRIEF DESCRIPTION OF THE DRAWINGS

FIG. 1 is a perspective view of a catalytic converter foil with non-linear channels;

FIG. 2 is a schematic top view of part of the catalytic converter foil of FIG. 1;

FIG. 3 is a schematic cross-sectional front view of part of the catalytic converter foil of FIG. 1;

FIG. 4 is a perspective view of two catalytic converter foil with non-linear channels alternatively interposed between two flat foils;

FIG. 5 is a perspective view of a catalytic converter foil with non-linear channels partially rolled about an axis;

FIG. 6 is a perspective view of two catalytic converter foils with non-linear channels partially rolled about an axis along with two flat foils; and

FIG. 7 is a perspective view of exhaust gas flowing through a particular embodiment of a catalytic converter.

### DETAILED DESCRIPTION

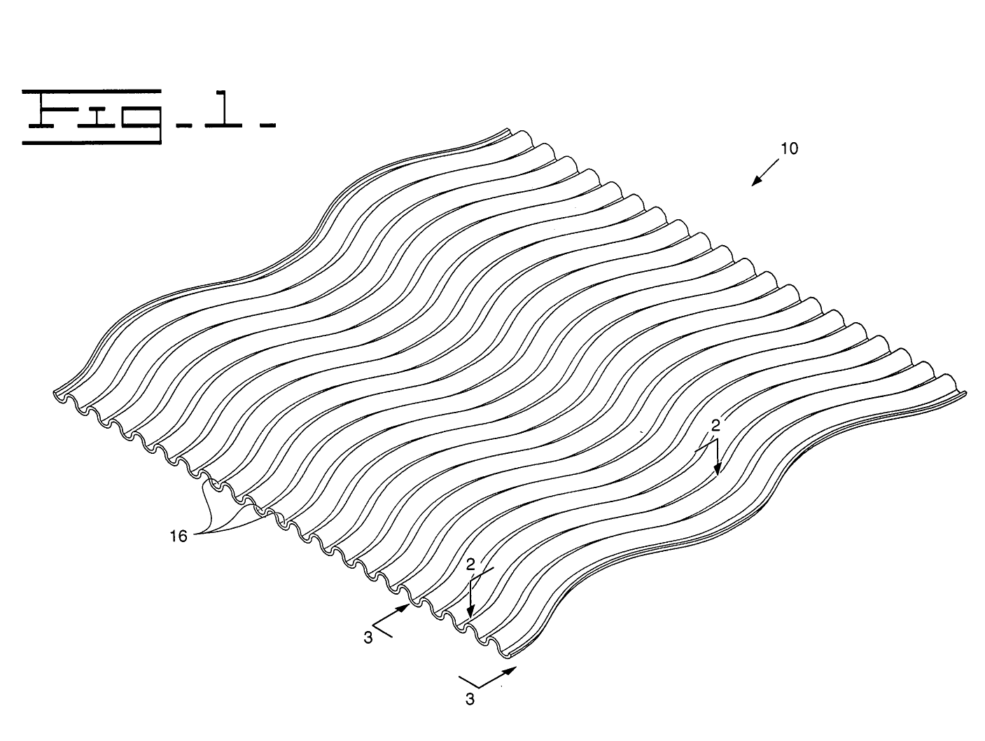

FIG. 1 is a perspective view of a catalytic converter foil 10 with non-linear channels 16. In this particular embodiment, channels 16 are sinusoidal in shape along the entire length of channels 16. Channels 16 are configured to receive fluid flow, such as exhaust gas 40 fluid flow, when formed as part of a catalytic converter 30 (shown in FIG. 7). The non-linear nature of channels 16 promotes turbulent fluid flow, which oftentimes increases the efficiency of the chemical catalyst.

Although the depicted channels 16 in FIGS. 1-7 are sinusoidal, the reader should appreciate that any non-linear channel 16 may be used. For example, channels 16 may comprise sharp corners, irregular contours that are inconsistent with a typical sine wave, and any other non-linear shape, so long as turbulent flow is generated in at least part of channel 16.

The reader should also appreciate that the non-linear nature of channel 16 need not be present during the entire length of channel 16. Although FIGS. 1-7 depict a non-linear wave being present along the entire length of channel 16, the disclosed embodiments are not limited to this structure. For example, channel 16 may include non-linear waves, bends, contours, or curves, for example, for only part of the length of channel 16. During the remainder of channel 16, channel 16 may be straight.

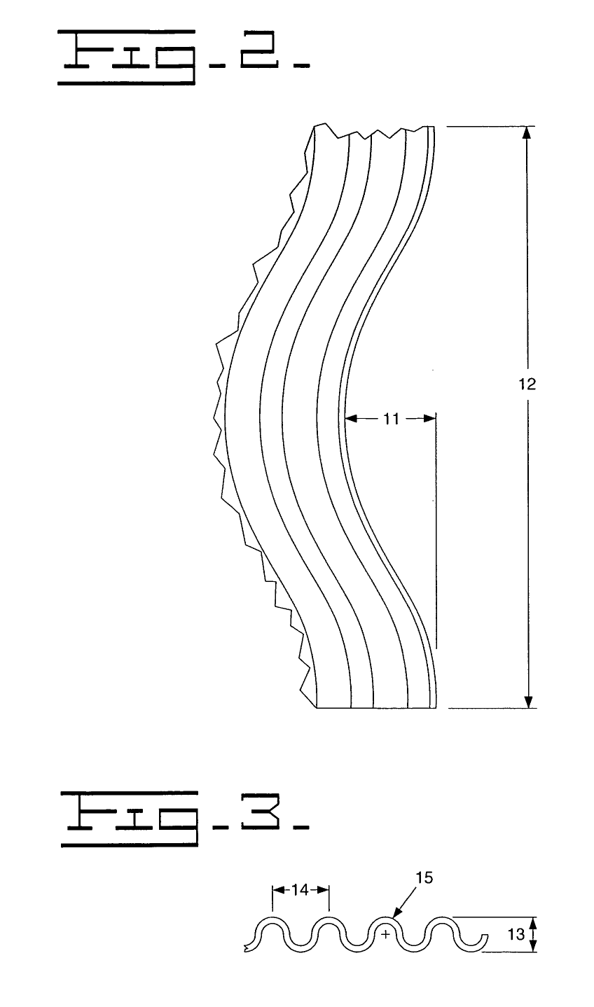

FIG. 2 depicts a partial top view of foil 10. As can be seen, foil 10 comprises sinusoidal channels 16 with amplitude 11 and period 12. In at least one embodiment, amplitude 11 is about 0.25 inches or less and period 12 is about 2.0 inches or less. Although FIG. 2 provides specific values for amplitude 11 and period 12, the reader should appreciate that several different values may be used to promote turbulent flow in channels 16. As previously discussed, the reader should appreciate that catalytic converter 30 is not limited to require channels 16 with sinusoidal shapes, as depicted, but may include any non-linear shape that promotes turbulent fluid flow.

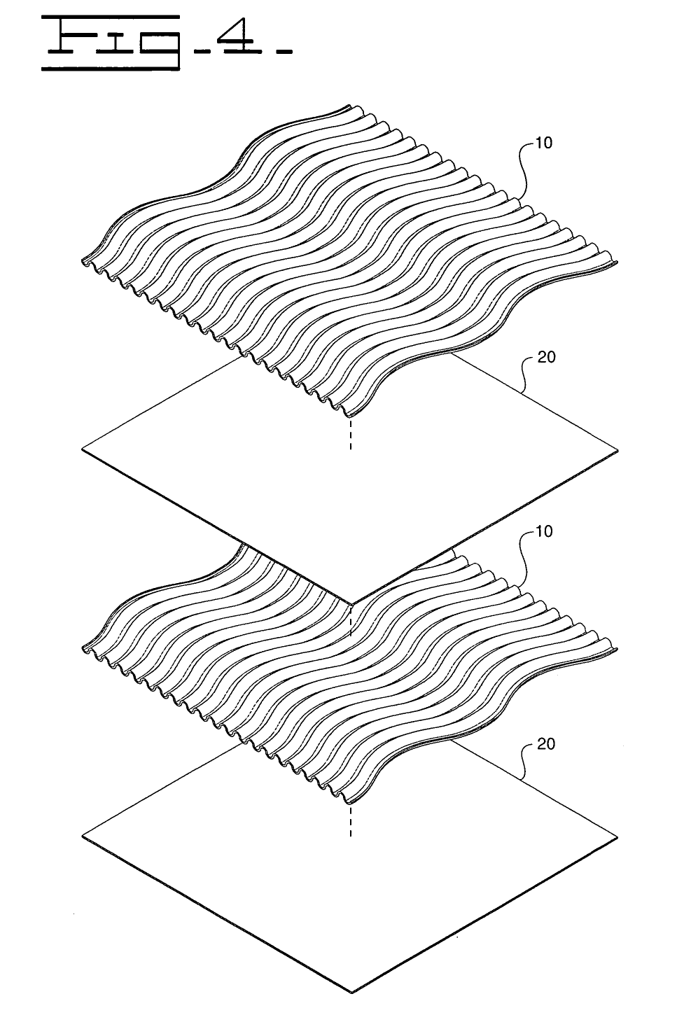

Now referring to FIG. 3, a partial front cross-sectional view of foil 10 is shown. As can be seen, foil 10, in addition to having sinusoidal channels 16 (shown in FIG. 1), is also rippled along its end. In this embodiment, the ripples have radius 15, amplitude 13, and period 14. In at least one embodiment, the radius 15 is about 0.038 inches, amplitude 13 is about 0.15 inches or less, and period 14 is about 0.15 inches or less. Although FIG. 3 provides specific values for radius 15, amplitude 13, and period 14, the reader should appreciate that several different values may be used in the design of foil 10 and channels 16 (shown in FIG. 1). Further, the reader should appreciate that catalytic converter 30 is not limited to require channels 16 with semi-circular or rippled cross sections, as depicted in FIG. 3, but may include any cross-sectional shape. For example, channels 16 may include polygonal cross-sectional shapes, such as trapezoidal, rectangular, or triangular shapes, just to name a few.

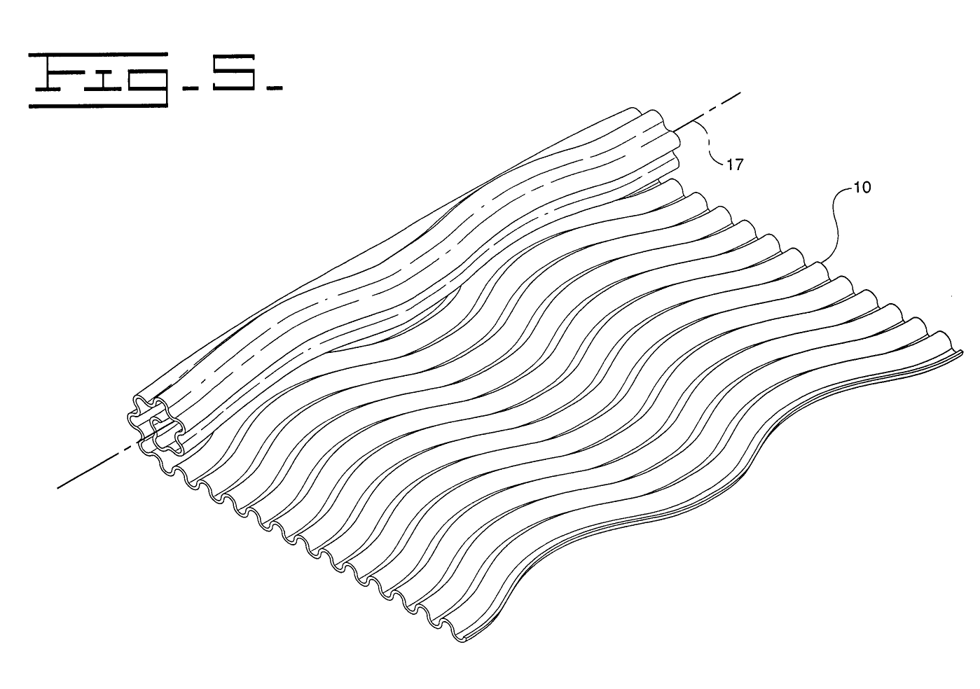

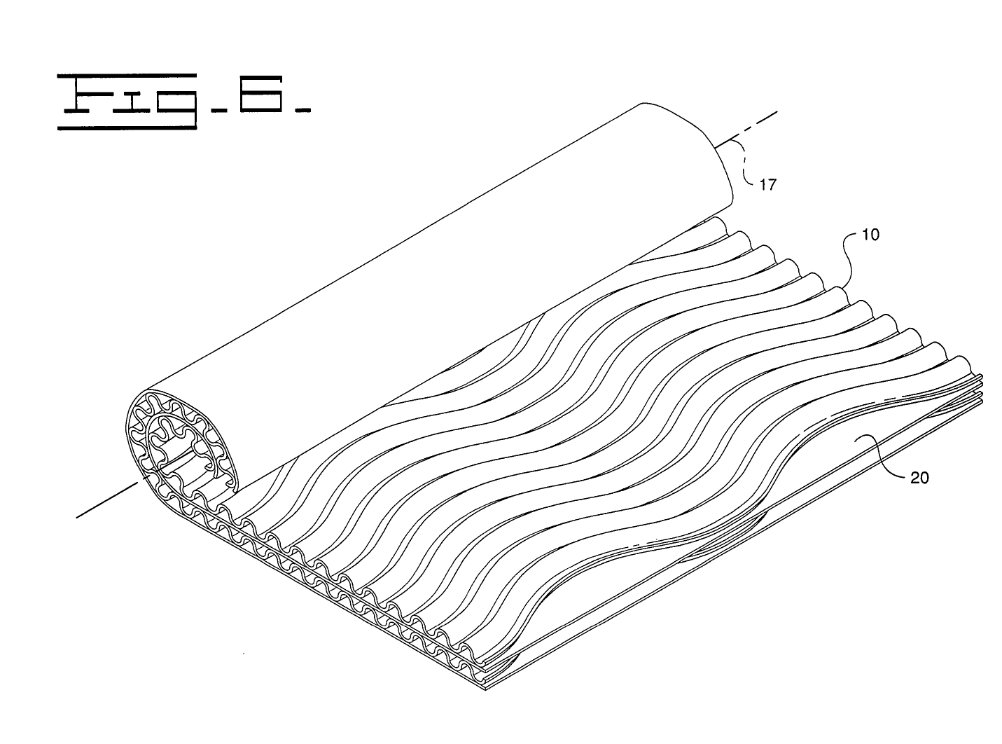

Referring now to FIGS. 4-7, catalytic converter 30 may be manufactured in several different ways. In one example and as depicted in FIG. 5, foil 10 may be rolled up to form the cylindrical catalytic converter 30, which is depicted in FIG. 7. In this example, axis 17 of the rolled converter 30 is substantially parallel to the direction of non-linear channels 16. Although the depicted embodiment illustrates axis 17 as being substantially parallel to channels 16, the reader should appreciate that foil 10 may also be rolled together about axis 17 such that axis 17 is not substantially parallel to the direction of non-linear channels 16. For example, foil 10 may be rolled about axis 17 such that the direction of channels 16 is offset at some angle with respect to axis 17. As long as converter 30 is capable of receiving exhaust flow 40 from one end 31 and sending exhaust gas to the other end 32, channels 16 may be aligned in any possible manner with respect to axis 17.

Additionally, the reader should appreciate that any number of foils 10 may be rolled together around axis 17 to form catalytic converter 30. For example, two, three, four, or five foils 10 may be rolled together to form catalytic converter 30.

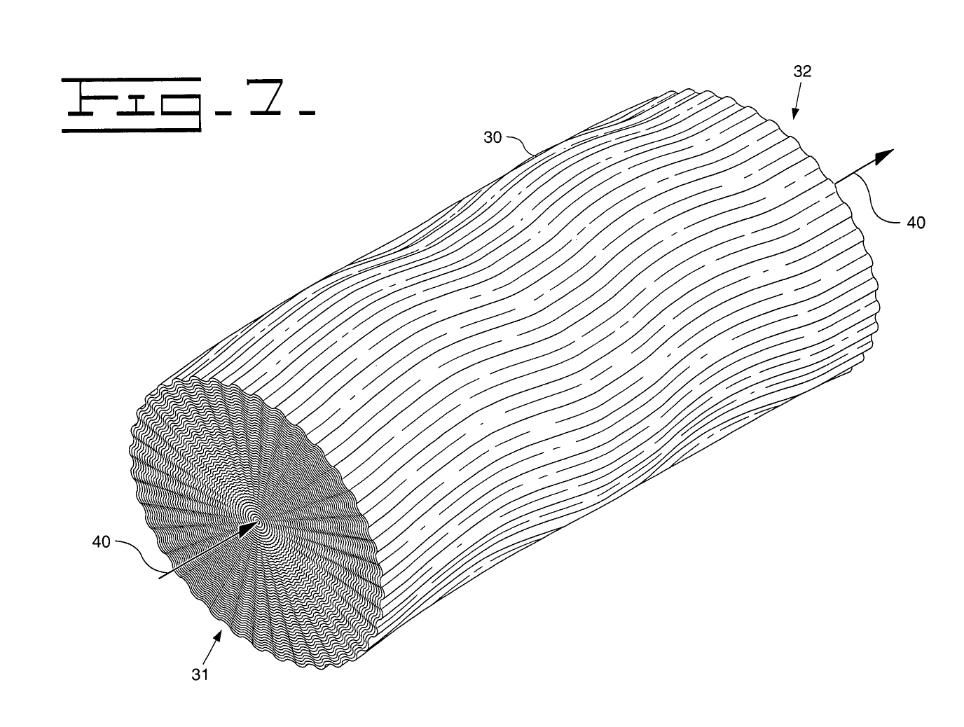

As depicted in FIGS. 4 and 6, catalytic converter 30 may alternatively be manufactured by placing two flat foils 20 adjacent to two sinusoidal foils 10. In this particular embodiment, foils 10 and 20 are rolled together about axis 17, such that axis 17 is substantially parallel to the direction of sinusoidal channels 16. As previously discussed, the reader should appreciate that foils 10 and 20 may also be rolled together about axis 17 such that axis 17 is not substantially parallel to the direction of sinusoidal channels 16.

In at least one embodiment, foil 10 and or foil 20 may be composed of any material that is known to one skilled in the art, including flexible materials. In one particular embodiment, foil 10 and foil 20 are composed of similar metals. In one example, foils 10 and 20 comprise aluminum. Additionally, foil 10 and or foil 20 may also be coated with a catalyst, such as palladium, rhodium, and or platinum, for example. In one particular embodiment, foils 10 and 20 are both coated with the same chemical catalyst.

There are several known catalysts that catalyze several different exhaust components that may be used in the disclosed converters 30. One skilled in the art would understand that the disclosed embodiments are not limited to catalyzing only hydrocarbons, carbon monoxides, and NOx.

### INDUSTRIAL APPLICABILITY

The disclosed catalytic converter 30 can be used in many different applications, including in the exhaust stream of an internal combustion engine. For example, catalytic converter 30 may be placed in a cylindrical housing (not shown) that receives exhaust gas 40 from an exhaust manifold of the engine. In such an application, exhaust gas 40 may be partially or fully catalyzed before being emitted into the environment or recirculated back into the engine's intake system—for engines with exhaust gas recirculation, for instance.

In operation and as shown in the particular embodiment of FIG. 7, exhaust gas 40 flows from left-to-right through catalytic converter 30. As gas 40 enters the left end 31 of catalytic converter 30, exhaust gas 30 may have unwanted constituents, such as hydrocarbons, carbon monoxides, and or NOx, for example.

As exhaust gas 40 enters catalytic converter 30, the environmentally-harmful exhaust constituents may be fully or partially converted to less-harmful products. During this conversion, the unwanted constituents interact with the catalyst, which facilitates the chemical reactions. By providing non-linear channels 16, the flow of exhaust gas 40 through converter 30 may be more turbulent, which results in better surface interaction between exhaust gas 40 and the chemical catalyst. As a result, more of the environmentally-harmful exhaust constituents are converted.

It will be apparent to those skilled in the art that various modifications and variations can be made with respect to the embodiments disclosed herein without departing from the scope of the disclosure. Other embodiments of the disclosed invention will be apparent to those skilled in the art from consideration of the specification and practice of the materials disclosed herein. It is intended that the specification and examples be considered as exemplary only, with a true scope of the disclosure being indicated by the following claims and their equivalents.

What is claimed is:

1. A catalytic converter, comprising:
at least one channel configured to receive gas flow; and
a catalyst coated on the at least one channel,
in which the at least one channel is at least partially non-linear along the channel's length.

2. The catalytic converter of claim 1, in which the at least one channel is at least partially sinusoidal in shape.

3. The catalytic converter of claim 2, in which the at least one channel is sinusoidal in shape along the channel's entire length.

4. The catalytic converter of claim 1, in which the at least one channel is non-linear along the channel's entire length.

5. The catalytic converter of claim 1, in which the at least one channel is manufactured from a metallic foil.

6. The catalytic converter of claim 1, further comprising at least one foil comprising the at least one channel, in which the at least one foil is interposed with at least one flat foil.

7. The catalytic converter of claim 6, in which the flat foil is coated with the catalyst.

8. The catalytic converter of claim 6, further comprising two foils comprising at least one channel, each of the two foils being alternatively interposed with two flat foils, and
in which the four foils are wound around an axis.

9. The catalytic converter of claim 1, in which the at least one channel comprises a semi-circular cross-sectional shape.

10. The catalytic converter of claim 1, in which the catalyst comprises at least one of platinum, palladium, or rhodium.

11. The catalytic converter of claim 5, in which the metallic foil comprises aluminum.

12. The catalytic converter of claim 1, in which the at least one channel has a rippled cross-section.

13. The catalytic converter of claim 2, in which the at least one channel has an amplitude of about 0.25 inches or less.

14. The catalytic converter of claim 2, in which the at least one channel has a period of about 2.0 inches or less.

15. The catalytic converter of claim 12, in which the ripple of the rippled cross-section has an amplitude of about 0.15 inches or less.

16. The catalytic converter of claim 12, in which the ripple of the rippled cross-section has a period of about 0.15 inches or less.

17. The catalytic converter of claim 12, in which the ripple of the rippled cross section has a radius of about 0.038 inches.

18. An exhaust system of an internal combustion engine, comprising:
an exhaust pipe in fluid communication with an exhaust manifold of the internal combustion engine;
a housing in fluid communication with the exhaust pipe; and
the catalytic converter of claim 1 housed within the housing,
in which the catalytic converter is configured to at least partially catalyze an exhaust constituent.

19. An exhaust system of an internal combustion engine, comprising:
an exhaust pipe in fluid communication with an exhaust manifold of the internal combustion engine;
a housing in fluid communication with the exhaust pipe; and
a catalytic converter housed within the housing, the catalytic converter comprising at least one channel configured to receive gas flow and a catalyst coated on the at least one channel, in which the at least one channel is at least partially sinusoidal along a length of the channel;
in which the catalytic converter is configured to at least partially catalyze an exhaust constituent.

20. The exhaust system of claim 19, in which the channel is fully sinusoidal along the channel's entire length.

21. The exhaust system of claim 19, in which the exhaust constituent comprises NOx, carbon monoxide, and/or hydrocarbons.

22. The exhaust system of claim 19, in which the catalytic converter comprises at least one foil comprising the at least one channel, the at least one foil being interposed with at least one flat foil.

23. The exhaust system of claim 22, in which two foils each comprising at least one channel are alternatively interposed with two flat foils and rolled about an axis.

24. The exhaust system of claim 19, in which the at least one channel has a rippled cross-section.

25. A method of manufacturing the catalytic converter of claim 1, comprising:
providing at least one first metal foil, said first metal foil being substantially flat;
providing at least one second metal foil, said second metal foil comprising non-linear channels; and
wrapping the at least one first metal foil and the at least one second metal foil around an axis.

26. A method of manufacturing a catalytic converter, comprising:
providing at least one first metal foil, said first metal foil being substantially flat;
providing at least one second metal foil, said second metal foil comprising non-linear channels; and
wrapping the at least one first metal foil and the at least one second metal foil around an axis.

27. The method of claim 26, in which the axis is substantially parallel to the non-linear channels.

28. The method of claim 26, in which the axis is transverse to the non-linear channels.

29. The method of claim 26, in which two flat foils are alternatively interposed with two foils with non-linear channels and wrapped around the axis.

30. A method of manufacturing a catalytic converter, comprising:
providing at least one foil, said foil comprising sinusoidal channels; and
wrapping the at least one foil around an axis.

31. The method of claim 30, in which the axis is substantially parallel to the non-linear channels.

32. The method of claim 30, in which the axis is transverse to the non-linear channels.
